(19) United States
(12) Patent Application Publication
(10) Pub. No.: US 2015/0176404 A1
(43) Pub. Date: Jun. 25, 2015

(54) Apparatus and Method for Subsea Testing

(71) Applicant: Nautilus Minerals Pacific Pty Ltd, Milton, Queensland (AU)

(72) Inventor: Glen Smith, Milton (AU)

(73) Assignee: Nautilus Minerals Pacific Pty Ltd, Milton, Queensland (AU)

(21) Appl. No.: 14/416,630

(22) PCT Filed: Jul. 10, 2013
(86) PCT No.: PCT/AU2013/000761

§ 371 Date: Jan. 22, 2015

(30) Foreign Application Priority Data
Jul. 27, 2012 (AU) 2012903242

(51) Int. Cl. E21B 49/02; G01N 27/72; G01N 23/222; G01N 23/223; E21B 47/12; E21B 25/18

(52) U.S. Cl. CPC E21B 49/025; E21B 47/12; E21B 25/18; G01N 23/222; G01N 23/223; G01N 27/72

(57) ABSTRACT

An apparatus and method for subsea testing of a core sample are provided. The apparatus includes a seafloor drilling rig that drills a borehole and obtains a sample from the seabed, and a sensor mounted on the seafloor drilling rig that analyses a portion of the sample after it is obtained. The sensor preferably includes an x-ray fluorescence sensor, a neutron activation analysis sensor, and/or a magnetic susceptibility sensor, and sends data about the core sample in real time, or at least near real time, to a surface vessel or platform.

### FIELD OF THE INVENTION

The invention relates to an apparatus and method for subsea testing. In particular, the invention relates, but is not limited, to an apparatus and method of testing seabed samples, typically core samples, using a sensor, preferably a spectroscopic sensor such as an x-ray fluorescence (XRF) and/or a neutron activation analysis (NAA), and/or a magnetic susceptibility sensor, mounted on a seabed drilling rig.

### BACKGROUND TO THE INVENTION

Reference to-background art herein is not to be construed as an admission that such art constitutes common general knowledge in Australia or elsewhere.

Seafloor drilling, particularly in fairly deep bodies of water (e.g. 1,000 m to 3,000 m+ below sea level), is a relatively complicated, time consuming, and expensive operation. Remotely operated systems, typically connected to a surface support vessel or platform by an ‘umbilical’ line, with a seafloor drilling rig have been known to be used for such drilling operations. A seafloor drilling rig typically includes a frame that provides support for various components such as a drill head support structure which would usually include a drill string capable of drilling a borehole in the seafloor.

One aspect of subsea drilling that is identified as being particularly onerous is in obtaining and analysing core samples. Typically a core barrel on the end of a drill string is used to obtain a core sample. Once the core barrel is filled, the core sample from the core barrel must then be retrieved. Typically the core barrel is first retrieved to the drilling rig and then later it is taken to the surface vessel or platform for extraction of the core sample and analysis.

A notable problem with this process in general is that it is not until the core samples have been retrieved and analysed that the composition of the seabed material is known. This time delay can be significant, and introduces a substantial inefficiency in understanding the characteristics of a borehole. One result of the time delay is that boreholes are often drilled past an optimum ‘end of hole’ (EOH) depth during drilling operations. This results in wasted drilling time and resources.

One method of trying to approximate an optimum EOH depth before the core samples are analysed at the surface is to have a camera located on the drilling rig that captures and transmits images of the core samples as they're removed from the drill string. The images can then be reviewed by an appropriately qualified operator who tries to assess whether the core sample appears, visually, to have drilled past the optimum EOH depth. Appreciably, this approach only works if the camera image is clear and a visual distinction is identifiable by the operator. Furthermore, it can suffer from human error which can negate the productivity benefits in visually reviewing the core samples before they are retrieved for analysis. It is also not possible to determine mineralised grade measurement data from such a visual analysis.

### OBJECT OF THE INVENTION

It is an aim of this invention to provide an apparatus and method for subsea testing which overcomes or ameliorates one or more of the disadvantages or problems described above, or which at least provides a useful alternative.

Other preferred objects of the present invention will become apparent from the following description.

### SUMMARY OF INVENTION

According to a first aspect of the invention, there is provided an apparatus for subsea testing of a core sample from a seabed, the apparatus comprising:

a seafloor drilling rig adapted to drill a borehole and obtain a sample from the seabed; and

a sensor mounted on the seafloor drilling rig that analyses at least a portion of the sample after the sample is obtained.

Preferably, the sensor comprises a spectroscopic sensor such as an x-ray fluorescence sensor and/or a neutron activation analysis sensor, and/or a magnetic susceptibility sensor.

Preferably, the sample is a core sample. Preferably the apparatus further comprises a sample manoeuvring system that receives the sample and moves it to a designated storage area. Preferably the designated storage area is a designated storage area of the seafloor drilling rig. Preferably the sensor is positioned on the seafloor drilling rig to analyse at least a lower portion of the core sample. In a preferred form the sensor analyses a bottom end of the core sample.

The sample manoeuvring system preferably further comprises a bracket which receives the sample from a drill string of the seafloor drilling rig. The bracket is preferably operated automatically and/or remotely. The bracket is preferably configured to move the sample adjacent the sensor. Alternatively, the sensor is arranged to analyse the sample when the sample is located in the designated storage area. The sample manoeuvring system may further comprise an arm or carousel that moves the bracket when actuated.

The sensor preferably analyses the sample to determine mineral composition and a mineral grade estimate of the sample. Preferably the sensor is in communication with a surface support vessel or platform. Preferably the sensor is in communication with the surface support vessel via an umbilical cable connected between the surface vessel or platform and the seafloor drilling rig.

According to a second aspect of the invention, there is provided a method of subsea testing of a core sample from a seabed, the method comprising the steps of:

operating a seafloor drilling rig to obtain a sample from the seabed; and

analysing at least a portion of the sample with a sensor that is mounted on the seafloor drilling rig.

Preferably, the sensor comprises a spectroscopic sensor such as an x-ray fluorescence sensor and/or a neutron activation analysis sensor, and/or a magnetic susceptibility sensor.

Preferably the sample is a core sample and preferably the seafloor drilling rig obtains the core sample from a borehole using a core barrel attached to a drill string. Preferably the method further comprises the step of manoeuvring the sample to a designated storage area. Preferably the step of manoeuvring the sample to a designated storage area comprises moving the core sample inside its core barrel to the designated storage area. Preferably the designated storage area is a designated storage area of the seafloor drilling rig. Preferably the sample remains inside its core barrel until the sample is retrieved to the surface support vessel or platform. The core barrel typically has at least one open end and the sensor preferably analyses an end portion of the sample accessible through the open end of the core barrel.

Preferably the sensor analyses at least a lower portion of the core sample. In a preferred form the sensor analyses a bottom end of the core sample.

The step of manoeuvring the sample (inside core barrel) to a designated storage area preferably comprises engaging the sample, typically via its core barrel, with a bracket. The bracket is preferably operated automatically and/or remotely. The bracket is preferably configured to move the sample adjacent the sensor. Alternatively, the sensor is arranged to analyse the sample when the sample is located in the designated storage area. The sample manoeuvring system may further comprise an arm or carousel that moves the bracket when actuated.

The method preferably further comprises transmitting data from the sensor to a surface vessel or platform. Preferably the data is transmitted in real time or near real time. Alternatively the data may be transmitted at a later time. The method preferably further comprises the step of determining mineral composition and a mineral grade estimate of the sample.

Preferably the method further comprises the step of locating the sensor adjacent the sample to be analysed. The sensor preferably comprises a waterproof housing that is pressure rated and pressure tested to the depth of use. The waterproof housing may have a transmissive window such as an x-ray fluorescence and/or neutron transmissive window. The step of locating the sensor adjacent the sample preferably comprises positioning the transmissive window towards the sample.

Preferably the seafloor drilling rig is operated from a surface vessel or platform. The seafloor drilling rig may also be automated or partially automated.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 is a diagrammatic view of a seafloor operation including a seafloor drilling rig operating in a borehole;

FIG. 2 is a diagrammatic view of the seafloor drilling rig including a core sample storage area and a sensor; and

FIG. 3 is a flow chart illustrating steps of a method of subsea testing using the sensor.

### DETAILED DESCRIPTION OF THE DRAWINGS

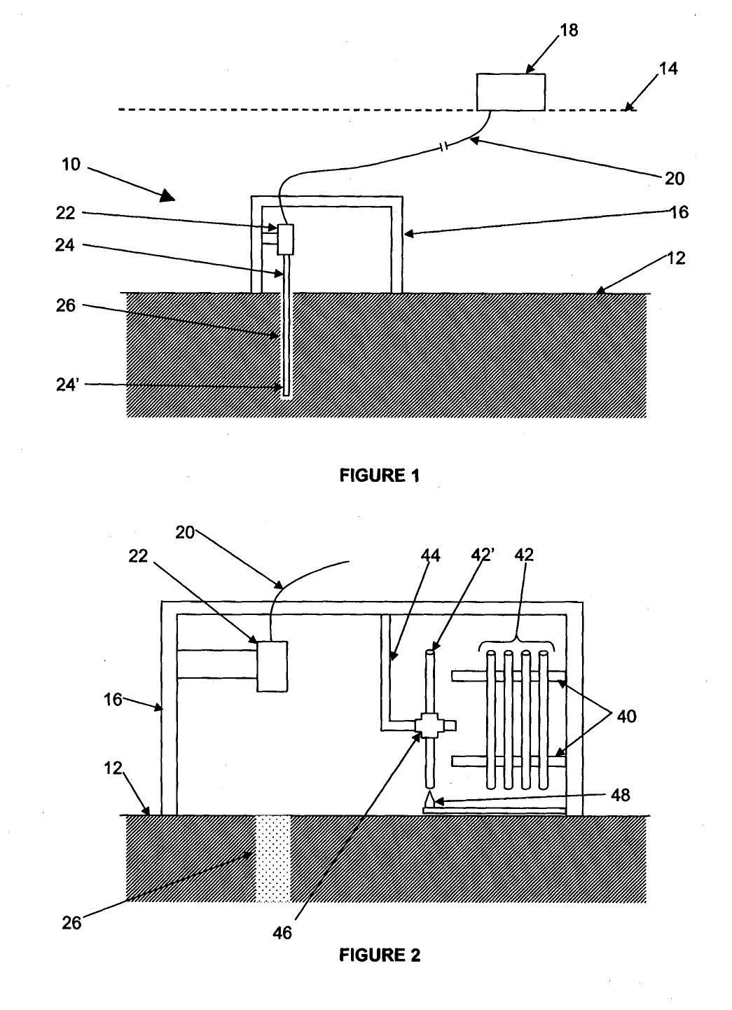

FIG. 1 illustrates a diagrammatic view of a seafloor drilling operation 10 located on a seafloor 12 below sea level 14. The seafloor drilling operation 10 may be located at various depths below sea level 14, but typically the seafloor 12 will be greater than 1000 m below sea level 14 and, in many cases, approximately 2000 to 3000 m below sea level 14.

The seafloor drilling operation 10 has a seafloor drilling rig 16 connected to a surface support vessel or platform 18 by an ‘umbilical’ cable 20. The umbilical cable 20 provides the seafloor drilling rig 16 with power, control, and telemetry. Typically the seafloor drilling rig 16 is powered and operated remotely, via umbilical cable 20, from the surface vessel or platform 18. Although the surface support vessel or platform 18 is illustrated as being located on the surface of the sea level 14, it will be appreciated that the surface support vessel or platform could also be located elsewhere, such as on land.

The seafloor drilling rig 16 has a drill head assembly 22 connected to a drill string 24 in a borehole 26. During drilling operations, the drill head assembly 22 controls the drill string 24 to drill the borehole 26. A typical drill string 24 has a conduit that transfers drilling fluid to a drill bit (not shown) of a bottom hole assembly at a distal end 24′ of the drill string 24. A core barrel (not shown) can also be secured at a distal end 24′ of the drill string 24 to obtain a core sample from the borehole 26.

FIG. 2 illustrates a diagrammatic view of the seafloor drilling rig 16 showing a designated core sample storage area in the form of a core sample rack 40 storing a plurality of core samples 42 (contained in core barrels). The seafloor drilling rig 16 also has a sample manoeuvring system 44 that has a bracket 46 that retains a core sample 42′ (via its core barrel) as it is moved from the drill head 22 to the designated core sample storage area 40.

A sensor in the form of an x-ray fluorescence sensor (XRF), a neutron activation analysis (NAA) and/or a magnetic susceptibility sensor 48 is mounted on the seafloor drilling rig 16. It will be appreciated that a single sensor in the form an XRF, NAA, or a magnetic susceptibility sensor will typically be provided. Alternatively, a combination of the XRF, NM, and/or a magnetic susceptibility sensor may be provided. Although multiple sensors could be provided, a single sensor 48 will typically be referred to for convenience.

The sensor 48 is positioned such that it analyses a bottom end of the core sample 42′ accessible through an open end of its core barrel, i.e. the end of the core sample 42′ that was lowest in the borehole 26. As the core samples 42 are retrieved from the borehole 26, the sensor 48 analyses them and provides information on the core sample.

Although the location of the sensor 48 is illustrated in FIG. 2 as being such that it analyses the core sample 42′ as it is manoeuvred by the sample manoeuvring system 44, it will be appreciated that the sensor 48 could also be mounted closer to the drill head 22 in order to analyse core samples 42 as they're removed from the borehole 26 or, alternatively, adjacent the core sample rack 40 such that it analyses the core samples 42 when they are in storage. An advantage of the latter location of the sensor 48 is that core samples can be analysed any time once they are in storage, allowing the core samples 42 to be analysed at a convenient time and, also, allowing samples to be readily analysed further.

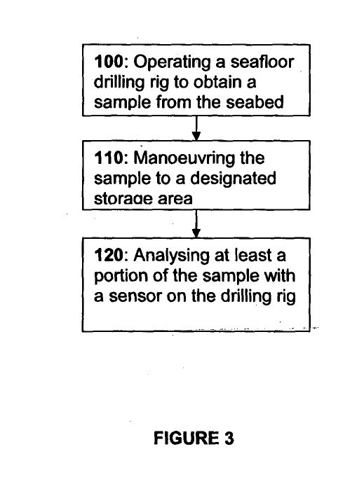

FIG. 3 is a flow chart illustrating steps of a. method of subsea testing of a core sample 42′ using a sensor 48 on a seafloor drilling rig 16. First, the seafloor drilling rig 16 is operated to drill a borehole and obtain a sample from the seabed (step 100). The sample is a core sample 42′ contained in a respective core barrel. A sample manoeuvring system receives the sample (inside its core barrel) and moves it to a designated storage area (step 110). A sensor 48 in the form of an XRF, NAA, and/or magnetic susceptibility sensor analyses at least a portion of the sample (step 120), preferably after the sample manoeuvring system receives the sample and optionally before the sample manoeuvring system moves the sample to the designated storage area.

Data from the XRF, NAA, or magnetic susceptibility analysis is transmitted in real time, or near real time, to the surface vessel or platform 18. Advantageously the invention allows testing of core samples 42 as they are retrieved from the borehole 26. The XRF, NAA, or magnetic susceptibility sensor 48 of the seafloor drilling rig 16 provides composition and mineral grade estimates of the core samples 42 which can be used to improve knowledge of the borehole 26, in particular when an optimum end of hole (EOH) is reached.

This improves drilling efficiency, particularly by determining when drilling should stop, and also in preventing erroneously stopping drilling too early.

The sensor 48 on the seafloor drilling rig 16 is easily utilised to provide relatively quick data collection and analysis on core samples 42, allowing quick and accurate assessments to be made on the drilling operations which in turn allows for informed decisions to be made in a timely manner. The composition and mineral grade estimates of the core sample 42′ can be determined or inferred using the XRF, NAA, or magnetic susceptibility sensor 48 data which advantageously provides valuable information on the state of the borehole 26 and, in particular, allows seafloor drilling operations to focus on areas of high value.

It will be appreciated that other sensors and measurements may also be made using different sensors, typically mounted on the seafloor drilling rig 16, and that these may assist in determining other characteristics of the core samples 42 and/or the environment.

References herein to the seafloor, seabed, subsea, or the like are for convenience only and could equally be applied to other bodies of water such as, for example, a lake with a lakebed, etc.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. An apparatus for subsea testing of a core sample from a seabed, the apparatus comprising:
a seafloor drilling rig adapted to drill a borehole and obtain a sample from the seabed; and
a sensor mounted on the seafloor drilling rig that analyses at least a portion of the sample after the sample is obtained.

2. The apparatus of claim 1, wherein the sensor comprises a spectroscopic sensor.

3. The apparatus of claim 2, wherein the spectroscopic sensor comprises an x-ray fluorescence sensor.

4. The apparatus of claim 2, wherein the spectroscopic sensor comprises a neutron activation analysis sensor.

5. The apparatus of claim 1, wherein the sensor comprises a magnetic susceptibility sensor.

6. The apparatus of claim 1, further comprising a sample manoeuvring system that receives the sample and moves it to a designated storage area of the seafloor drilling rig.

7. The apparatus of claim 6, wherein the sample manoeuvring system further comprises a bracket which receives the sample from a drill string of the seafloor drilling rig.

8. The apparatus of claim 7, wherein the bracket is configured to move the sample adjacent the sensor.

9. The apparatus of claim 6, wherein the sensor is arranged to analyse the sample when the sample is located in the designated storage area.

10. The apparatus of claim 1, wherein the sensor is positioned on the seafloor drilling rig to analyse a bottom end of the sample.

11. The apparatus of claim 1, wherein the sensor analyses the sample to determine mineral composition and/or a mineral grade estimate of the sample.

12. The apparatus of claim 1, wherein the sensor is in communication with a surface support vessel or platform.

13. The apparatus of claim 12, wherein the sensor is in communication with the surface support vessel or platform via an umbilical cable connected between the surface vessel or platform and the seafloor drilling rig.

14. A method of subsea testing of a core sample from a seabed, the method comprising the steps of:
operating a seafloor drilling rig to obtain a sample from the seabed; and
analysing at least a portion of the sample with a sensor that is mounted on the seafloor drilling rig.

15. The method of claim 14, wherein the sensor comprises a spectroscopic sensor.

16. The method of claim 15, wherein the spectroscopic sensor comprises an x-ray fluorescence sensor.

17. The method of claim 15, wherein the spectroscopic sensor comprises a neutron activation analysis sensor.

18. The method of claim 14, wherein the sensor comprises a magnetic susceptibility sensor.

19. The method of claim 14, wherein the method further comprises the step of manoeuvring the sample to a designated storage area.

20. The method of claim 19, wherein the designated storage area is a designated storage area of the seafloor drilling rig.

21. The method of claim 19, wherein the step of manoeuvring the sample to a designated storage area comprises moving the sample, inside a core barrel, to the designated storage area.

22. The method of claim 21, wherein the core barrel has at least one open end and the sensor analyses an end portion of the sample accessible through the open end of the core barrel.

23. The method of claim 14, wherein the sensor analyses a lower portion of the core sample.

24. The method of claim 14, further comprising the step of transmitting data from the sensor to a surface vessel or platform.

25. The method of claim 24, wherein the data is transmitted from the sensor to the surface vessel or platform in real time or near real time.

26. The method of claim 24, wherein the data is transmitted via an umbilical cable.

27. A method of generating data relating to a core sample from a seabed, the method comprising the steps of:
operating a seafloor drilling rig to obtain a sample from the seabed;
analysing at least a portion of the sample with a sensor that is mounted on the seafloor drilling rig; and
generating data relating to the core sample from the sensor analysing the sample.
